(19) United States
(12) Patent Application Publication
(10) Pub. No.: US 2003/0229643 A1
(43) Pub. Date: Dec. 11, 2003

(54) Creating a footprint of a computer file

(75) Inventor: Thomas Huguenard, Claremora, OK (US)

Correspondence Address: ELMER GALBI, 13314 VERMEER DRIVE, LAKE OSWEGO, OR, 97035

(73) Assignee: Digimarc Corporation, Tualatin, OR

(21) Appl. No.: 10/157,702

(22) Filed: May 29, 2002

(51) Int. Cl. G06F 17/00

(52) U.S. Cl. 707/102

(57) ABSTRACT

A method and system for identifying files by calculating a unique table of values for the file. The calculated values in the table constitute a “footprint” of the file. A first embodiment works for any type of files. A second embodiment is particularly useful in identifying image files. In the first embodiment, for each possible value of the bytes that form the file, the offset of the first occurrence of a byte with the particular value, the offset of the last occurrence of a byte with the particular value, and the number of occurrences of the bytes with the particular value are calculated. These values are stored in a table and termed prominence values. The prominence values uniquely identify the file. In a second embodiment, an image file is broken into relatively small cells. The cells with the highest and lowest average values of quantities such as luminance, red chrominance, etc. are determined. The cells with these values are the prominences for the particular image. Vectors which describe the location of the prominence cells are calculated and saved. The values of the various quantities in the prominence cells and the vectors pointing to the location of these cells provide a footprint for the image.

### FIELD OF THE INVENTION

The present invention relates to computer systems and more particularly the present invention relates to the identification of computer files.

### BACKGROUND OF THE INVENTION

Hashing is a well known process which transforms a string of data (or a computer file) into a key that represents the file or string of data. The key usually has a fixed length and it is usually shorter than the original data. Hashing is frequently used to index items in databases. In general it is faster to find an item in a data bases using the shorter hashed key than to find it using the original value. Hashing is also frequently used in encryption algorithms.

A hash function is a transformation that takes an input and returns a string, which is called the hash value. If “H” represents a hash function and “h” represents a hash value, then, h=H(m).

In general a good hash function should not produce the same hash value for two different inputs. If a hash function provides the same hash value for two different inputs, this is known as a collision. A hash function that offers an extremely low risk of collision may be considered acceptable in many applications. A hash function can be “weakly collision free” or “strongly collision free”. A hash function H is weakly collision-free if given a string “x” if it is not computationally infeasible to find a string “y” not equal to “x” such that H(x)=H(y), then . A hash function H is strongly collision-free if it is computationally infeasible to find any two messages x and y such that H(x)=H(y).

A hash function “H” is termed “hard to invert” (or it is referred to as a “one way hash function”) if it is computationally infeasible to find some input x such that H(x)=h.

There are many different hash functions. A hash function that works well for database storage and retrieval might not work as for cryptographic or error-checking purposes. Thus, hash functions are generally designed for a particular purpose.

A relatively simple type of hashing that is often used in communication systems is termed a cyclic redundancy check or CRC. A cyclic redundancy check code is incorporated in transmission data frames to determine whether or not a bit error has taken place during transmission.

Cyclic redundancy check codes (CRC codes) have many uses. For example, in computer networking CRC codes provide a very powerful and easily implemented tool to insure reliability. CRCs are easy to implement and they can detect a large class of errors. The mathematics underlying CRCs is well known to those skilled in the art of error control coding.

Many network packets (for example, Ethernet packets) have CRC codes to help guarantee error free delivery. In such systems, the transmitter generates the CRC code and places it in the packet trailer. The receiver validates that the CRC in the received packet matches a CRC calculated using the received packet.

The basic mathematics underlying hashing and CRC codes is well known. There are many issued patents that relate to hashing and CRC codes, For example, see issued U.S. Pat. No. 5,724,538 and issued U.S. Pat. No. 6,308,246.

### SUMMARY OF THE PRESENT INVENTION

The present invention provides a method and system for identifying a file by calculating a unique table of values for the file. The calculated values in the table constitute a “footprint” of the file. The footprint can be used to determine if a particular file is a copy or a duplicate of another file. Two embodiments of the invention are described. The first embodiment works for any type of files. The second embodiment is particularly useful for identifying image files. In the first embodiment, for each possible value of the bytes that form the file, the offset of the first occurrence of a byte with the particular value, the offset of the last occurrence of a byte with the particular value, and the number of occurrences of the bytes with the particular value are calculated. These values are stored in a table and are termed prominence values. The prominence values uniquely identify the file. A second embodiment is particularly adapted to image files. With the second embodiment an image file is broken into relatively small cells. The cells with the highest and lowest average values of quantities such as luminance, red chrominance, etc. are determined. The cells with these values are the prominences for the particular image. Vectors which describe the location of the prominence cells are calculated and saved. The values of the various quantities in the prominence cells and the vectors pointing to the location of these cells provide a footprint for the image.

### BRIEF DESCRIPTION OF THE FIGURES

FIG. 1 is a program flow diagram of a first embodiment of the invention.

FIG. 2 is a program flow diagram of a second embodiment of the invention.

### DETAILED DESCRIPTION

The purpose of the present invention is to provide a relatively small table of values that uniquely identifies a file. That is, the table of values provides a footprint of the file. The footprint of a file can alternately be described as the “fingerprint” of the file.

If one has a file and one wants to determine if the file is a copy of another file, one can calculate the identifier table for each of the two files and if the identifier tables are identical it means that the files are identical. The identifier tables are structured in such a way that for all practical purposes only one particular file can produce a particular identifier table. That is, as a practical matter, two different files will not produce the same identifier table. The invention can be implemented as a computer program on a general purpose computer or it can be implemented by hard wired circuitry that performs the logic that is described.

Two embodiments of the invention will be described. The first embodiment can be used with any type of file. For example, it can be used with an image file such as with JPEG or MPEG image files; however, the first embodiment can also be used with other types of files such as COM, EXE or DOC files. The second embodiment is designed explicitly for image files.

In files which have eight bits per byte (which is normal), each byte in the file has one of 256 possible values (0 through 255). With the first embodiment of the invention, the number of occurrences of each possible byte value is counted and the offset of the first and last occurrence is recorded. The values so determined are recorded in a table such as the following:

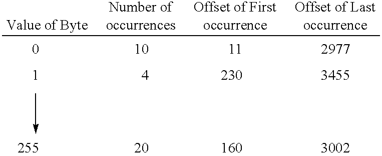

A table such as the above has 256 rows and four columns. It can be used to uniquely identify a file with many tens of thousands of bytes. Thus, a relatively small table, provides an unique “footprint” or “fingerprint” which will uniquely identify a relatively large file. As used herein the term “footprint” and “fingerprint” are used interchangeably.

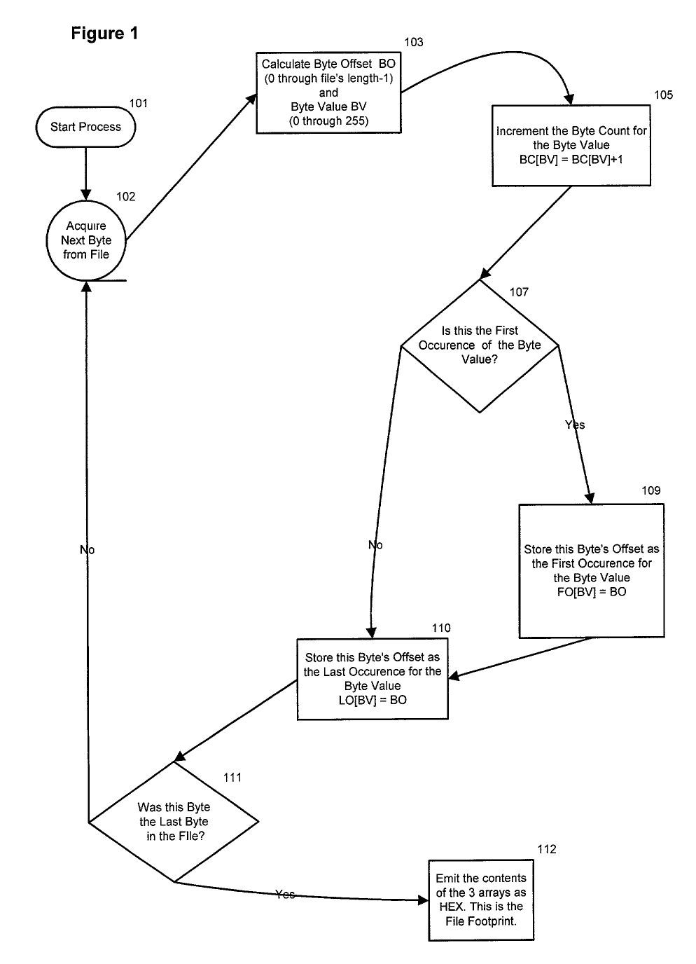

A flow diagram of a program that operates in accordance with the first embodiment of the invention is given in FIG. 1. The process starts at block 101. A byte is acquired from the file being “fingerprinted” as indicated by block 102. The value of the particular byte and its offset (i.e. its location in the file) is determined as indicated by block 103. A counter (not explicitly shown) associated with the particular byte value is incremented as indicated by block 105. This counter keeps track of how many times the particular byte value has occurred. Decision block 107 determines if this is the first time the particular byte value has occurred. That is, is the count in the counter in block 105 equal to “1”.

If this is the first occurrence of the particular value, its offset is stored as indicated by block 109. The offset is also stored as indicated by block 110, as the temporary last occurrence of the byte. Block 111 determines if all bytes in the file have been examined. If the end of the file has been reached the footprint table has been established as indicated by block 112. If the end of the file has not been reached to program proceeds to block 102 and the process is repeated.

In summary the program illustrated by the flow diagram in FIG. 1, examines a file of bytes and produces a table such as the table given above. The values in the table uniquely identify the file. If one takes two files and makes the described calculations on the byte values in the file so that two tables are produced, one for each of the files, one can compare the tables to determine if the files are identical. It is noted that comparing the vales in the table is much simpler than comparing the byte values in the files themselves. The number of entries that constitute the tables is fixed and relatively limited. On the other hand the files can be very large.

An alternative embodiment of the invention is specifically adapted to produce a fingerprint of an image file. The second embodiment takes an image and divides the image into regions, each of which contain 256 pixels. That is, the image is divided into regions each of which cover an area of 16 by 16 pixels. These 16 by 16 pixels region are called cells.

Each cell is examined as described below to determine if it constitutes a prominence. A prominence is a cell, which compared to the other cells in the image, contains the highest or lowest concentration of a particular quantity such as luminance, red chrominance, blue chrominance, green chrominance, etc. The values of a particular quantity for all the pixels in a cell are averaged to obtain the value of that quantity for a cell. A prominence can also be the highest or lowest (compared to other cells in an image) of a combination of quantities such as the total of the luminance and the red chrominance.

Thus for an image, certain particular cells will have the highest and lowest values of a particular defined quality. These cells are called prominence cells for that image.

After the prominence cells are located, vectors that describe relative position of the prominence cells in the image are calculated. A “circle of vectors,” is calculated. That is, a vector goes from each prominence to another prominence forming a circle of vectors. For example, vectors are calculated starting with the high red chrominance cell to the high green chrominance cell to the high blue chrominance cell to the low red chrominance cell to the low green chrominance cell to the low blue chrominance cell and finally back to the high red chrominance cell. The circle includes each of the prominence cells. The vectors are normalized by dividing their vector lengths by the vector length of the red-green vector and by rotating the vector angles by subtracting the red-green vector angle. The luminance and chrominance values are also normalized by dividing them by the high prominence value of the associated color's prominence.

A table is constructed to record the value of the selected quantities such as the red chrominance, the blue chrominance, the green chrominance and luminance values for the prominence cells. In an example where the prominences are calculated for red chrominance, green chrominance, blue chrominance and luminance, the result is a table which provides a footprint or fingerprint of an image file will be as the follows.

PROMINENCE TABLE

Vector to next
Prominence

| | Magnitude | Angle | Distance |
|---|---|---|---|
| Red High | | | |
| Red Low | | | |
| Green High | | | |
| Green Low | | | |
| Blue High | | | |
| Blue Low | | | |
| Luminance High | | | |
| Luminance Low | | | |

It should be understood that which quantities are chosen for calculation of prominences depends on the particular application. In simple applications, one, two or a few quantities will be chosen such as in the above example. In more complex applications, many quantities and combinations of those quantities will be chosen. Any quantity which is defined for the pixels in the particular image, along with combinations of those quantities can be used to calculated prominence cells.

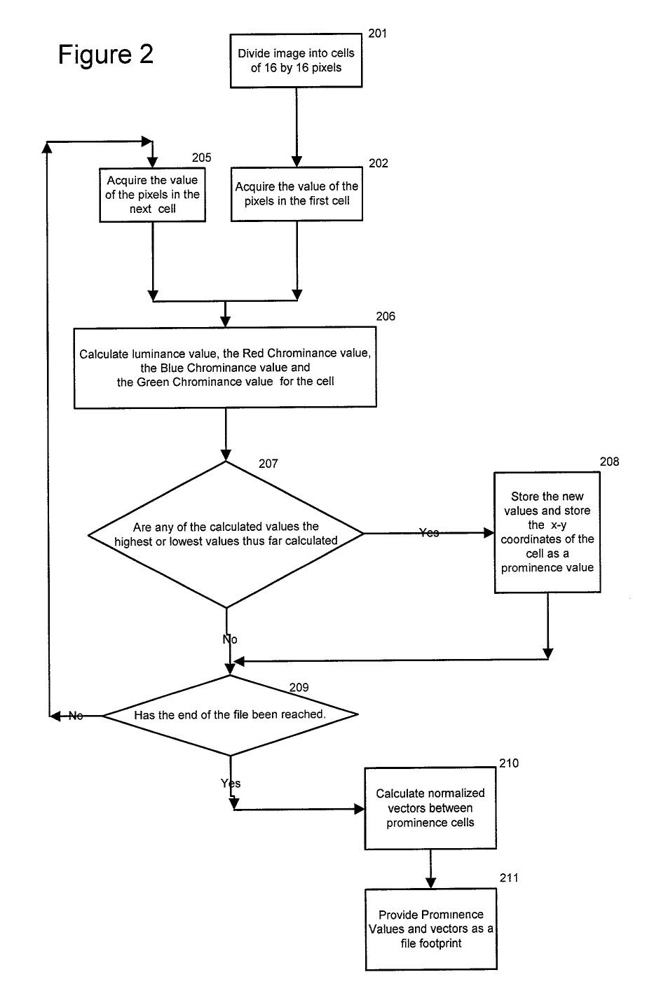

A program flow diagram of a program to calculate the above table is given in FIG. 2. The program will in effect fill in values for the above table. At the beginning of the process as indicated by block 201, the image being “foot printed” is divided into cells, each cell is 16 pixels wide by sixteen pixels high. A particular cell is then selected for processing as indicated by block 202. The cells can be selected in any order. Next the as indicated by block 206, all of the selected quantities are calculated for the selected cell. The value of the selected quantity for all the pixels in a cell are averaged to get the value of the quantity of the cell. Each particular application can have its own list of selected quantities. Any quantity that is given for each pixel (and combinations of those quantities) can be selected. In the example illustrated in FIG. 2 and in the above table, the selected quantities which are calculated to find prominences are red chrominance, blue chrominance, green chrominance and luminance. As indicated by block 207, the calculated quantities are compared to the highest and lowest values previously found for the particular quantity. If any quantity is found to have a higher value than previously found for the image under evaluation, the new value and the location of the cell is stored as indicated by block 208. Blocks 209 and 206 cause the operation to loop through each of the cells in an image.

After all of the cells have been processed, normalized vectors between the cells are calculated as indicated by block 210. A “circle of vectors,” is calculated. For example, vectors are calculated starting with the high red chrominance to the high green chrominance to the high blue chrominance to the low red chrominance to the low green chrominance to the low blue chrominance and finally back to the high red chrominance. The circle includes each of the prominence cells. The vectors are normalized by dividing their vector lengths by the vector length of the red-green vector and by rotating the vector angles by subtracting the red-green vector angle. The luminance and chrominance values are also normalized by dividing them by the high prominence value of the associated color's prominence.

Finally as indicated by block 211, the prominence values and vectors are provided as a footprint of the file.

It is noted that the values calculated in the first embodiment can be considered to be prominence values for a file, and the offsets that are recorded in the first embodiment of the invention are to some extent equivalent to the vectors recorded in the second embodiment of the invention.

If desired, a single system can employ both of the above described embodiments of the invention and decide which of the two embodiments to use as follows: when a file is presented to the system, the system could first try to use the second embodiment of the invention. If the second embodiment can not be used (i.e. the file is not an image) the system could then use the first embodiment. it is noted that the first embodiment operates with any type of file.

The first embodiment can be modified as follows to further insure that no two files produce the same footprint. This alterative uses four counters termed 1, 3, 5, 7 counters as follows: at the beginning of the process, each of four counters is initialized to 0. For each byte in the file, the first counter is incremented by the byte value. The second counter is incremented in the same way, but only for every third byte. The third and fourth counters are incremented in the same way, at every 5th and 7th byte respectively. These counters are can be 16 bit counters, that roll over when their value exceeds 65535. These four count values can be appended to the footprint value to provide additional identification for the file. Various other combinations of counters can also be used.

It is noted that while the two embodiments described each uniquely identify a file, the second embodiment can identify an image file even though the file has undergone one or more transformations. For example, an image may be rotated, scaled, stretched, darkened, lightened. The second embodiment of the invention will correctly identify an image that has been thus modified and indicate that the image is substantively identical to the original image. With the first embodiment such transformation would change the contents of the file and hence the footprint would be changed.

The first embodiment requires less calculations than the second embodiment and it is particularly useful for the identification of non-image files. For example the first embodiment could be used in a system where when, a user “right clicks” on a file in the Microsoft Windows Explorer, the user would be presented with an “Identify” option. When activated, this option would execute a network call to a server which has a data base of file ownership information. The server would compare the footprint table of the file on which the user clicked, to tables stored in the server. If a match is found the user could be provided with a dialog box which give the name, owner, date of creation, purpose, associated system, whether it is safe to delete the file, etc.

The invention could also be used in an intelligent backup system. In such a system, each file's footprint is calculated and stored on a server along with its disk location. This is done instead of storing the entire file on the server. For any file with no footprint on file, the actual file is backed up on the server. When a backup is to be restored, the server provides a network path for each file that needs to be restored, and the intelligent backup pulls the file off the network. This greatly decreases the time needed for file system backups, while ensuring the integrity of the data.

The invention can also be used to store a footprint, rather than actual files, in a file system. When a file is called for by the operating system (say a user wishes to run a program ABC.EXE), the operating system places a call over the network to download a copy of the file. The downloaded file can be used and destroyed after use.

It is noted that the first embodiment was described with respect to the use of bytes each of which had 256 possible values. The invention can also be used for other types of bytes or bit sequences. As is well known, in general a sequence or byte of n bits has 2n possible values.

While the invention has been shown described with respect to various embodiments thereof, it should be understood that a wide variety of other embodiments are possible without departing from the scope of the invention. The invention is limited only by the appended claims.

I claim:

1) A method of calculating a footprint of a file which uniquely identifies the file, said file containing a number of bit sequences of length n bits, each of which has a number (2^{N}) of possible values, said method including the steps of, determining for each possible particular value of a bit sequence, the number of times a bit sequence having said particular value occurs in said file, and recording the number of times said particular value occurred along with the offset of the first and last occurrence of said particular value, whereby said recorded values form a footprint of said file.

2) A method of calculating a footprint for an image file comprising the steps of dividing said image into cells,
determining the particular cells in an image which have the highest and lowest values for particular quantities,
calculating vectors that describe the relative positions of said particular cells,
whereby said vectors and said highest and lowest values provide a footprint of the file.

3) The method recited in claim 2 wherein said particular quantities includes luminance.

4) The method recited in claim 2 wherein said particular quantities includes red chrominance.

5) The method recited in claim 2 wherein said particular quantities includes blue chrominance.

6) The method recited in claim 2 wherein said particular quantities includes green chrominance.

7) The method in claim 2 wherein the lowest and highest values of a quantity for a cell is calculated by averaging that quantity of all the pixels in the cell.

8) A method of calculating a set of values which constitute a footprint for an image, said method comprising the steps of
dividing said image into cells,
determining the particular cells in an image which constitute prominences in said image, and
calculating vectors that describe the relative positions of said prominences,
whereby said vectors and said prominences provide a footprint of the file.

9) A method of calculating a set of values which uniquely identifies a file, said file containing a number of bytes, each of which has 256 possible values, said method including the steps of,
determining for each possible particular value of said bytes, the number of times a byte having said particular value occurs in said file, and recording the number of times the particular value occurred along with the offset of the first and last occurrence of the particular value, whereby said recorded values form a footprint of said file.

10) A system for calculating a set of values which constitute a footprint for an image, said system including a program for
dividing said image into cells,
determining the particular cells in an image which constitute prominences in said image, and
calculating vectors that describe the relative positions of said prominences,
whereby said vectors and said prominences provide a footprint of the file.

11) The method recited in claim 8 where said prominences are cells which have the highest or lowest value of particular quantities.

12) The method of claim 9 where the prominences are determined by calculating the average value of a quantity for the pixels in a cell.

13) A method of calculating a set of values which uniquely identifies a file, said file containing a number of bytes, each of which has a plurality of possible values, said method including the steps of,
determining for each of said plurality of values, the number of bytes in said file having said value, and recording the number of times each the particular value occurred along with the offset of the first and last occurrence of the particular value, whereby said recorded values form a footprint of said file.

14) The method recited in claim 2 wherein each of said cells has the same number of pixels.

15) The method recited in claim 2 wherein each of said cells has 256 pixels.

16) A system that calculates a footprint of a file, said footprint uniquely identifying said file, said file containing a number of bit sequences of length N bits, each of which has a number (2^{N}) of possible values, said system including a computer program which determines for each possible particular value of a bit sequence, the number of times a bit sequence having said particular value occurs in said file, and recording the number of times said particular value occurred along with the offset of the first and last occurrence of said particular value, whereby said recorded values form a footprint of said file.
